(19) United States
(12) Patent Application Publication
(10) Pub. No.: US 2012/0020667 A1
(43) Pub. Date: Jan. 26, 2012

(54) DATA STREAM UPGRADE APPARATUS AND METHOD

(75) Inventors: Steven Mutabazi, Melbourne (AU); Lee Nguyen Binh, Melbourne (AU)

(73) Assignee: AUSANDA COMMUNICATIONS PTY LTD, Melbourne (AU)

(21) Appl. No.: 12/744,284

(22) PCT Filed: Nov. 21, 2008
(86) PCT No.: PCT/AU2008/001734

§ 371 Date: Nov. 2, 2010

(30) Foreign Application Priority Data
Nov. 21, 2007 (AU) 2007906357

(51) Int. Cl. H04J 14/02

(52) U.S. Cl. 398/79

(57) ABSTRACT

A method to transmit and receive significantly larger serial data stream to achieve conformance to the signal interface constraints of a pre-installed transmission system thus minimising bit error rate for both the large serial data streams and the pre-installed streams the method includes the steps of de-serialising an initial incoming signal into M data streams, wherein M>2, each M data stream having a data rate of D/M Gbps, partially serialising and encoding M data streams into K symbol groups where K is an integer greater than or equal to 1, each K symbol group characterized by N concurrent data bits of the N data streams, wherein each N data stream has a data rate of D/(N·K), processing each of the K symbol groups to provide one modulated output signal the K modulated output signals then being transmitted via K channels of an existing wavelength division multiplexing system, so as to enable transmission of significantly large data streams over pre-installed transmission networks.

### FIELD OF THE INVENTION

The present invention relates to optical fibre wavelength division multiplexing (WDM) communication systems and more particularly relates to a method and apparatus to enable carriage by a pre-installed WDM system of serial data streams at least four times greater than the channel capacity of the WDM system.

### DESCRIPTION OF THE PRIOR ART

The current era of exponential growth in bandwidth demand has created a significant economic problem for telecommunication carriers attempting to maintain a reasonably high return on capital they invested in transmission systems.

While transmission technology in the form of dense wavelength division multiplexing (DWDM) systems is now capable of transporting terra bits per second of data, the manner in which it is deployed is increasingly leading to sub-optimal return on capital invested in this technology by telecommunication carriers.

For example, during the mid 1990s DWDM systems had a maximum capacity approximately 20 channels each supporting data streams of 2.5 Gbps and therefore supporting an aggregate data stream of 50 Gbps. In order to support higher aggregate data streams, the technology evolved to 40 channels with each channel supporting a serial data stream of 10 Gbps for an aggregate data stream of 400 Gbps. DWDM systems further evolved to deliver a further doubling of the number of channels to around 80 channels, but this time it was not possible to support larger data streams beyond 10 Gbps. More recently, DWDM systems are able to support serial data streams of 40 Gbps, but with reduced channel count from to 80 back to approximately 40, and a system total capacity of 1.6 Tbps.

With such growth in size of serial data streams supported by DWDM systems it is not intuitively obvious as to why telecommunication carriers should be experiencing sub-optimal economic scenarios as they consider deploying DWDM systems to keep pace with the growth in telecommunications bandwidth demand.

The issue for telecommunication carriers is that in order to deploy the new generations of DWDM systems they must make a transition from their pre-installed system to a new system based on the new generation of DWDM technology. For example they are required to transition from 40-channel with 10 Gbps channel capacity to the 80-channel generation which also has 10 Gbps channel capacity. Similarly deployment of 40 Gbps channel capacity requires a whole new system optimized for that capacity, and of course capable of carrying lower capacity channels, such transition requires the lighting up of a new fibre pair, and installing new generation equipment including terminal equipment and line amplifiers at intervals of approximately 100 km along the transmission path. The largest economic disincentive is the requirement to use a new fibre pair. Its cost is much more significant than the cost of the DWDM equipment.

Because of this economic disincentive carriers are restricted in their freedom to aggregate telecommunications traffic to appropriately large volumes for transmission as one large serial data stream. In recognition of this issue, the telecommunications industry recently sanctioned the development of a new Ethernet standard to support 100 Gbps transmission, preferably as a serial data stream.

Given the economic disincentive that telecommunication carriers face when faced with the prospect of deploying a succession of generations of DWDM systems, it is necessary that pre-installed DWDM networks predominantly supporting a given size of serial data streams should also support significantly larger serial data streams so as to afford carriers the opportunity to amortize pre-installed transmission infrastructure over a longer time frames than the recent experience of about five years.

The majority of pre-installed DWDM systems serial data streams of 10 Gbps are based on the International Telecommunication Union (ITU) channel spacing standards of 50 GHz and 100 GHz. Deploying significantly larger serial data stream such as 100 Gbps alongside these existing 10 Gbps serial data streams presents significant technical challenges for prior art because higher data rates require greater channel spacing.

These technical challenges are best explained in the context of an installed DWDM network. FIG. 1 is a block diagram of a typical DWDM transmission network 1000 with terminal equipment 1010, optical add-drop multiplexing (OADM) equipment 1020, optical line amplifiers 1030 located at transmission intervals 1040 of approximately 100 km. In order to maintain clarity, other components of DWDM systems are not shown.

The terminal equipment 1010 and the OADM equipment comprises among other components multiplexing and de-multiplexing units 1015 with a channel interface 1050 supporting pre-installed client channel equipment 1011 operating at the existing data rate of 10 Gbps.

In order to support significantly larger serial data streams it is necessary to deploy advanced client channel equipment 1012 which comply with the existing channel interface 1050 requirements. These requirements include but are not limited to a maximum power level for the signals launched to any one channel, signal resilience to chromatic dispersion, phase mode dispersion and the effect of fibre nonlinearities during transmission. Uniformity across the pre-installed client channel 1011 equipment and the advanced client channel equipment 1012 is required in order to achieve error free transmission over the infrastructure along the transmission path.

This compliance requirement leads to significant technical challenges. The first technical challenge is that the advanced client channel equipment 1012 must launch power into the channel interface 1050 at level designed to suit much lower data rates of the pre-installed channel equipment. Ordinarily if the higher data rates were transmitted according to prior art, correspondingly higher launch power would be required to achieve comparable transmission performance.

The second challenge is that multiplexing and de-multiplexing units 1015 have a comparatively narrow signal pass band commensurate with the low data rate. The advanced client channel equipment 1012 must therefore conform to the comparatively narrow signal pass band. Finally along the transmission path the signals corresponding to the larger signal data streams must not suffer adverse effects during transmission over the transmission interval 1040 and through the line amplifier equipment 1030.

In addition to these technical challenges lies a more serious challenge. The serial data streams envisaged for a new generation of transmission channels represent a significant jump from current serial data streams of 10 Gbps. For example the current proposal involves a jump from 10 Gbps to 100 Gbps. Future increases in the serial data streams will also be large. It is generally agreed that the current electronic components and their use in prior art cannot support transmission of very high serial data streams such as 100 Gbps.

However, a commercial need has been expressed for very large serial data streams such as 100 Gbps and beyond. Therefore a new method and apparatus are required to overcome these technical challenges and provide the freedom to aggregate telecommunications traffic to appropriately large volumes for transmission as one large data stream, and to transmit these significantly large data streams over pre-installed transmission networks.

### OBJECT OF THE INVENTION

It is an object of the invention to provide a method and apparatus for fitting to a pre-installed DWDM transmission system to increase its capacity to transmit and receive large amounts of data. It is an object of the present invention to overcome, or at least substantially ameliorate, the disadvantages and shortcomings of the prior art.

Other objects and advantages of the present invention will become apparent from the following description, taking in connection with the accompanying drawings, wherein, by way of illustration and example, an embodiment of the present invention is disclosed.

### SUMMARY OF THE INVENTION

According to the present invention, although this should not be seen as limiting the invention in any way, there is provided a method and apparatus to transmit and receive significantly larger serial data stream to achieve conformance to the signal interface constraints of a pre-installed transmission system thus minimising bit error rate for both the large serial data streams and the pre-installed streams the method includes the steps of:
1. de-serialising an initial incoming signal 2010 at a first data rate D into M data streams, wherein M>2, each M data stream having a data rate of D/M Gbps, framing and error coding the M data streams in accordance with established standards, within the processing capabilities of prior art;
2. partially serialising and encoding M data streams into K symbol groups where K is an integer greater than or equal to 1, each K symbol group characterized by N concurrent data bits of the N data streams;
3. wherein each N data stream has a data rate of D/(N·K);
4. processing each of the K symbol groups to provide one modulated output signal;
5. the K modulated output signals then being transmitted via K channels of an existing wavelength division multiplexing system

In preference, the processing of each K group includes the steps of:
1. modulation pulse forming, N bits at a time;
2. optical modulation, N bits per symbol; and
3. signal conditioning.

In preference, the data rate of D/(N·K) is less than a clock speed of the serialising and encoding processors;

In preference, the processor includes an N-bit encoder.

In preference, the N-bit encoder generates N-bit symbols in groups K to correspond with constraints of the pre-installed transmission system.

In preference, N≦3, that is 3 bits per symbol is the minimum.

In preference, the signal is conditioned such that the wavelength transmitted in relation to each K-symbol group has a negative initial residual chromatic dispersion and the residual chromatic dispersion is appropriately trimmed at the receiver of the transmission system.

### BRIEF DESCRIPTION OF THE DRAWINGS

By way of example, an employment of the invention is described more fully hereinafter with reference to the accompanying drawings, in which:

FIG. 1 is an example of a prior art system.

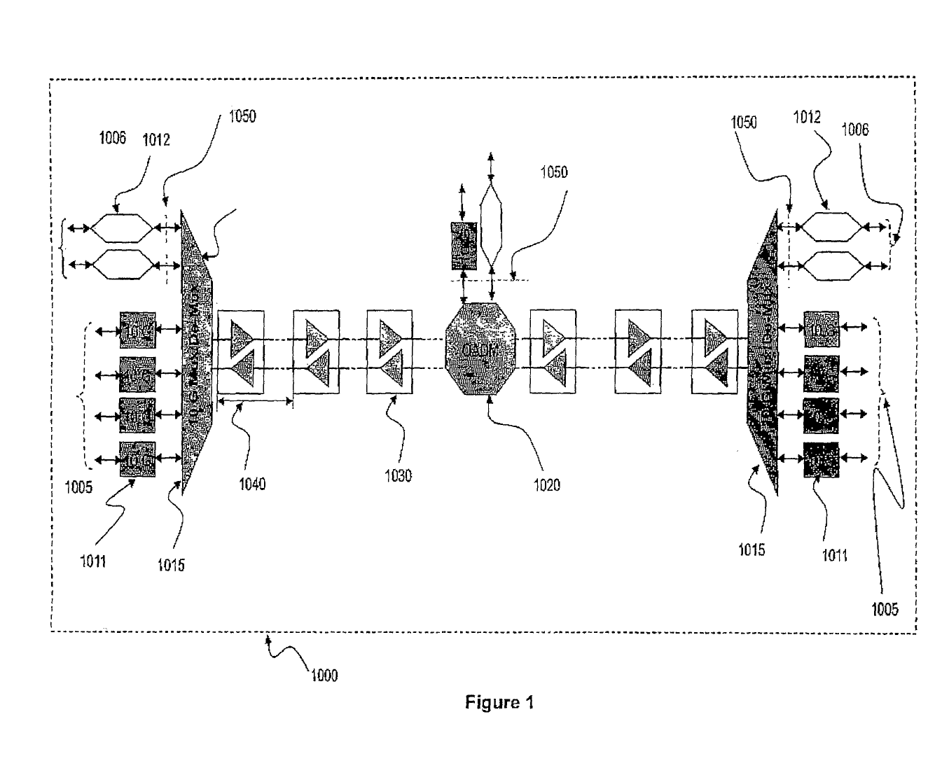

FIG. 2a is a block diagram of embodiment of the current disclosure in a transmitting functionality;

FIG. 2b is a block diagram of embodiment of the current disclosure in transmitting functionality where the transmitting functionality has been reduced to exclude the de-serializer and framer 2030, exposing the standards-compliant interface 2015.

FIG. 3a is a block diagram of embodiment of the current disclosure in a receiving functionality;

FIG. 3b is a block diagram of embodiment of the current disclosure in receiving functionality where the receiving functionality has been reduced to exclude the de-framer and serializer 3020, exposing the standards-compliant interface 3015.

FIG. 4a is an example of the present disclosure, in transmitting functionality where the present disclosure in partial serializer and N-bit encoder 2040, and the N-bit driver 2050 are used to drive an N-bit per symbol modulator constructed using optical components of prior art. N=4.

FIG. 4b is an example of the present disclosure similar to the example of FIG. 4a, but reduced to exclude the de-serializer and framer 2030, exposing the standards-compliant interface 2015.

FIG. 4c is an example of the present disclosure similar to the example of FIG. 4b, but where the N-bit per symbol modulator a different combination of prior art optical components.

FIG. 5 is the Gray mapping phasor diagram associated with the example in FIG. 4a of the present disclosure.

### DETAILED DESCRIPTION OF THE INVENTION

Various modifications may be made in details of design and construction [and process steps, parameters of operation etc] without departing from the scope and ambit of the invention.

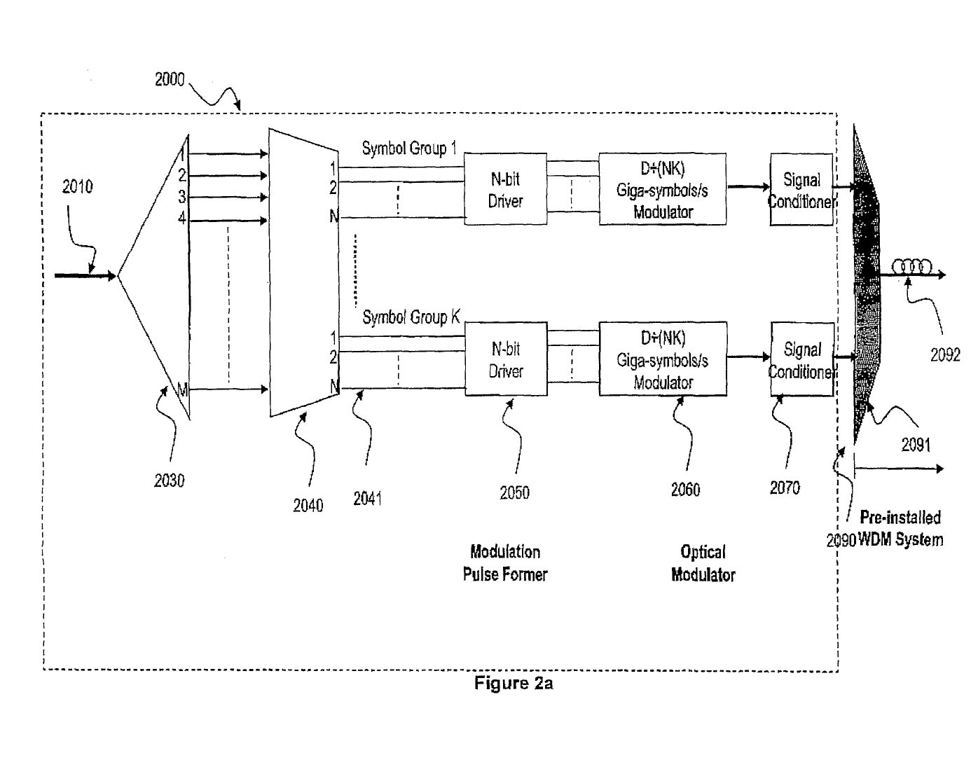

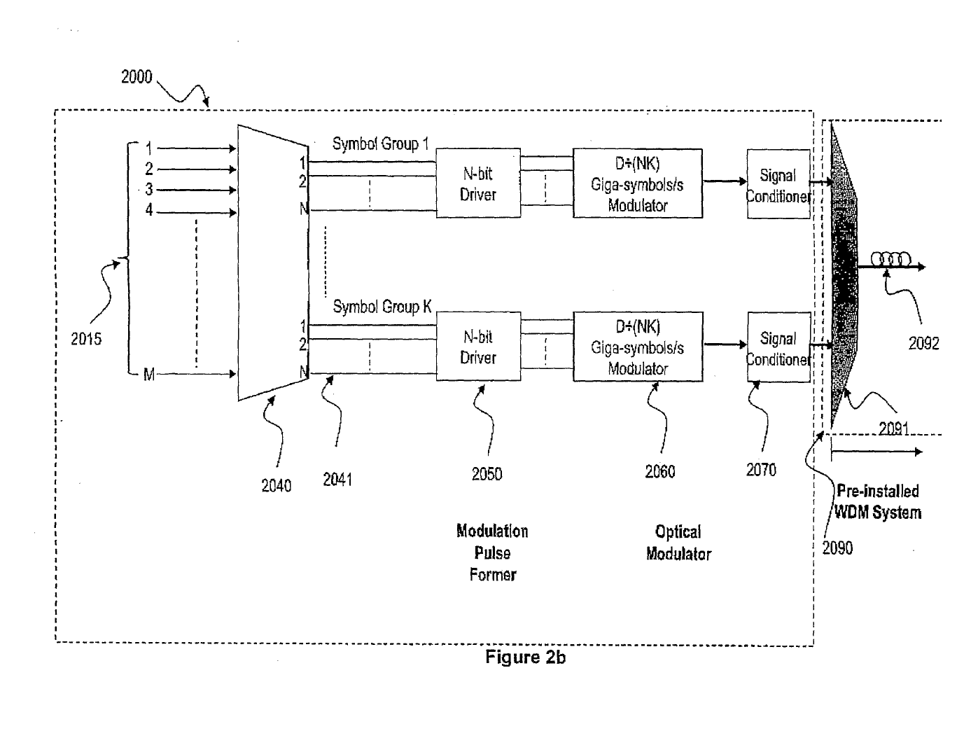

FIG. 2a is a block diagram depicting the functions of a transmitter 2000 as an exemplary embodiment of the present invention. The transmitter 2000 according to the present invention consists of a de-serializer and framer 2030 which among other functions:
1. Aligns the signal of the large serial data stream 2010 with applicable ITU and other industry standards at its output, and presented through a standardized physical interface such as 300-pin connector;
2. Converts the large serial data stream 2010 of a total data rate of D Gbps, into M parallel data streams where M is sufficiently large to reduce data rate for each of the M parallel data streams to a low rate within the processing capability of the prevailing electronic processing technologies. For example a 40 Gbps serial data stream over existing 10 Gbps transmission system the data stream may be de-serialized to 16 streams (M=16) of slightly greater than 2.5 Gbps to allow for framing overheads and error correction coding. Also for example when transmitting large serial data stream 2010 of 100 Gbps over existing 10 Gbps systems, the value for M may be set to 20 so as to reduce the data rate for each of the M parallel data streams to the order of 5 Gbps; and
3. Adds framing overheads and error protection coding.

The M parallel data streams form the inputs of the N-bit encoder 2040 which encodes the M parallel data streams into a smaller number of parallel data streams, organized in K symbol groups 2041 each group comprising N streams, and each transmitting D/(NK) symbols per second. For example when transmitting a large serial data stream 2010 of 100 Gbps with N=4 and K=2, the effective symbol rate for each of the K symbol groups is 12.5 Giga symbols/s. If K is set to 1 then the symbol rate of the single symbol group doubles from 12.5 Giga symbols per second to 25 Giga symbols per second.

The signals of each of the K symbol groups 2041 drive the N-bit modulation pulse former 2050 in turn generating N concurrent pulses that drive the optical modulator 2060. Each of the modulator output signals (2061) is preferably conditioned by a signal conditioner 2070. Each of the conditioned signals is launched into a pre-existing channel of the transmission system 2090 at the multiplexing/de-multiplexing stage 2091 for transmission over the fibre plant 2092.

The large serial data stream 2010 may contain specific transmission protocols in form of bit stream overheads. Where format translation is required to meet optical transmission network (OTN) specifications, this function is preferably carried out by the de-serializer and framer 2030.

The de-serializer and framer 2030 is preferably constructed using currently available electronic components used in prior art. However because prior art data streams are relatively smaller, a nesting of these components may be necessary when de-serializing the large serial data stream 2010.

The framer functions of the de-serializer and framer 2030 are preferably constructed using a nest of programmable processors of prior art, equipped with software algorithms also of prior art, matched to the task of handling the large array of M parallel data streams generated within the de-serializer and framer 2030.

The N-bit encoder 2040 according to this invention differs from prior art in that it functions with a larger number of inputs corresponding to the M parallel data streams and generates N-bit symbols in groups matched to the constraints of the transmission channel of the pre-installed system. The number of bits per symbol N is set to a minimum of 3. By contrast prior art operates with one serial input, has a maximum of 2-bit symbols and supports one channel transmission. As a result the N-bit encoder 2040 according to this invention is superior in its scalability to handle increasing sizes of large serial data streams 2010, by using the highest achievable combination of the variables N and K to attain the lowest symbol rate as set out in the present disclosure.

While constructed using prevailing electronics technologies the modulation pulse former 2050 according to this invention also differs from prior art in that it functions with N input streams and transmits N modulation pulse as opposed to 1 input stream and a maximum of 2 modulation pulses at the output.

While constructed using prevailing electronic and optical technologies the optical Modulator 2080 according to this invention also differs from prior art in that it functions with N inputs per symbol transmitted as opposed to a maximum of 2 inputs per symbol transmitted in prior art.

An example is used here to explain the modulation process of the present invention. This should not be seen as limiting the invention in any way.

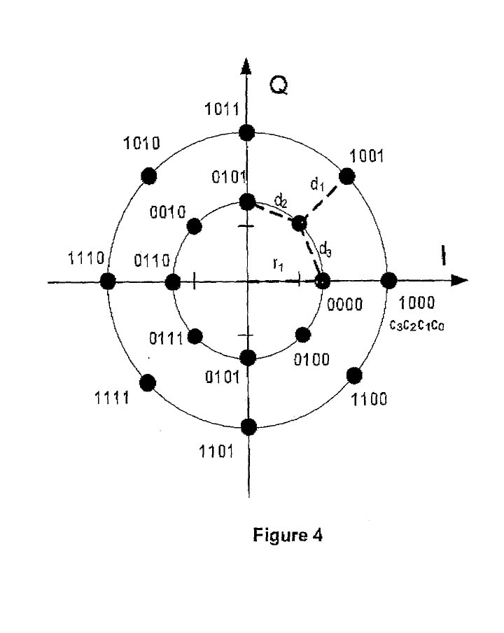

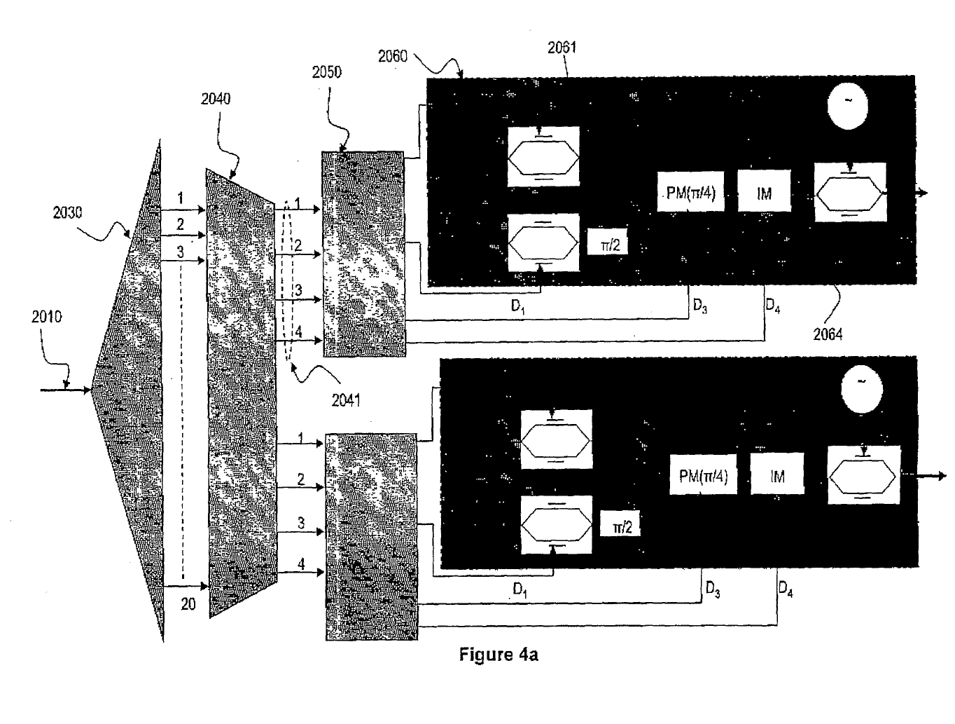

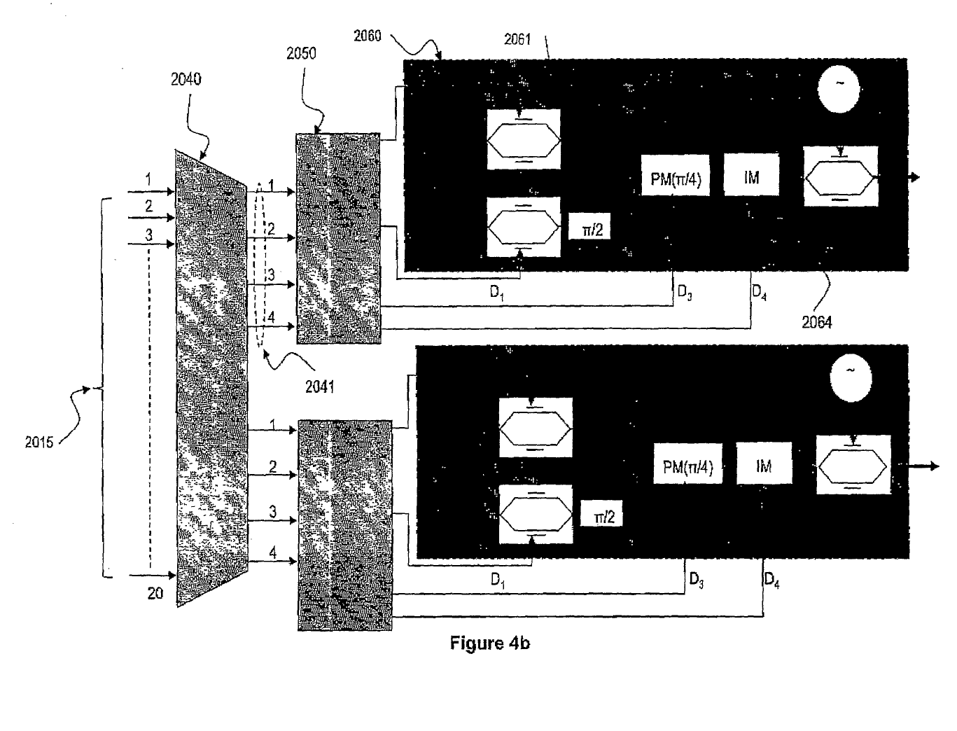

FIGS. 4a, 4b and 4c are illustrative examples of how this invention can be used to transmit a large serial data stream of for instance 100 Gbps, over two channels of DWDM systems optimized to carry 10 Gbps serial data streams.

The modulation process of the current invention encodes N bits of the data stream into one symbol to drive the modulator. In this example N=4. Assuming that the large serial data stream 2010 is 100 Gbps, the design of FIG. 4a would operate as follows:
1. In FIG. 4a the de-serializer and framer 2030 maps and frames the large serial data stream into 20 small data stream of 5 Gbps plus overheads. FIGS. 4b and 4c represent the instance when the large serial data stream is already processed into M streams and therefore the de-serializer and framer 2030 function is not required.
2. For N=4, the N-bit encoder 2040 generates two sets of four streams at 12.5 Gbps plus overheads each, where the coincident bits of the four streams form the 4 bits that define the symbol to be transmitted. These four bits are used by the modulation pulse former 2050 to generate the four concurrent pulses that drive the optical modulator 2060.

The first two bits which are applied to the duel drive Mach-Zehnder modulator 2061 and the third bit which is applied to the phase modulator 2062 determine the phase of the symbol to be transmitted. The fourth bit which is applied to an intensity modulator 2063 determines the amplitude of the symbol.

At each k^{th} instance, the absolute phase of transmitted light waves θₖ is expressed as:

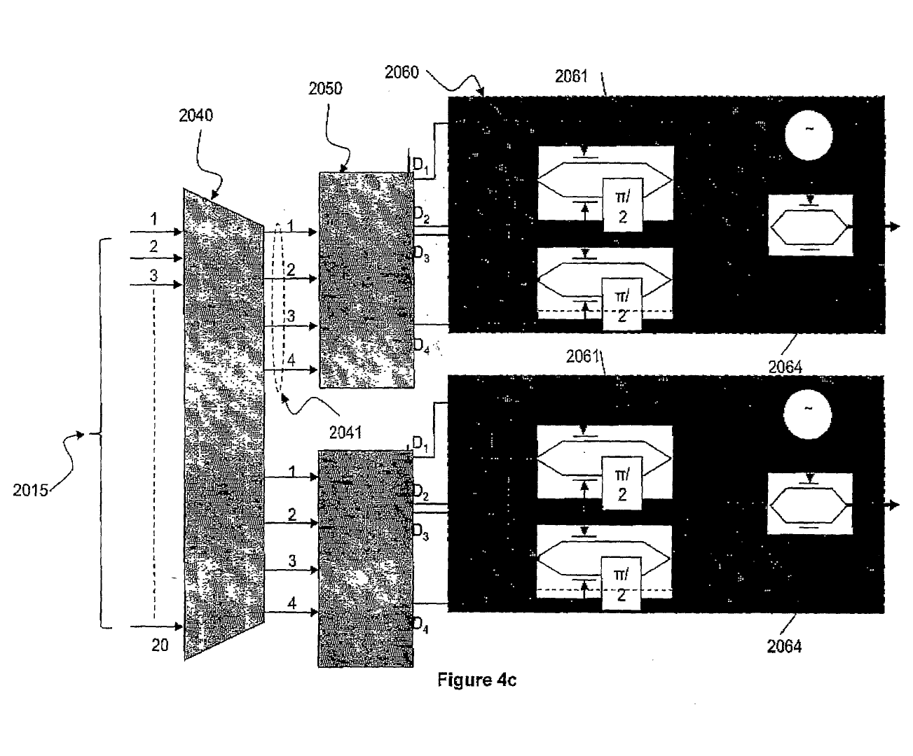

θₖ=θₖ₋₁+θₖ where θₖ₋₁ is the phase at (k−1)^{th} instance and Δ θₖ is the coded phase information. The encoding of this Δ θₖ follows the well-known Gray mapping rules. As illustrated in the Gray mapping phasor diagram depicted in FIG. 5. The phasor is normalized with the maximum energy on each branch, i.e. E₁/2.

The amplitude levels are optimized in order that the Euclidean distances d₁, d₂, and d₃ are equal, i.e d₁=d₂=d₃. After derivation, r₁=0.5664. The I and Q field vector corresponding to Gray mapping rules are shown in Table 1.

TABLE 1
I and Q field vectors of the modulation scheme.

| Binary Sequence | (Δθₖ⁻¹, Amplitude) | Iₖ | Qₖ |
|---|---|---|---|
| 1000 | (0, 1) | 1 | 0 |
| 1001 | (π/4, 1) | \sqrt{2}/2 | \sqrt{2}/2 |
| 1011 | (π/2, 1) | 0 | 1 |
| 1010 | (3π/4, 1) | −\sqrt{2}/2 | \sqrt{2}/2 |
| 1110 | (π, 1) | −1 | 0 |
| 1111 | (−3π/4, 1) | −\sqrt{2}/2 | −\sqrt{2}/2 |
| 1101 | (−π/2, 1) | 0 | −1 |
| 1100 | (−π/4, 1) | \sqrt{2}/2 | −\sqrt{2}/2 |
| 0000 | (0, 0.5664) | 1*0.5664 | 0 |
| 0001 | (−π/4, 0.5664) | \sqrt{2}/2*0.5664 | \sqrt{2}/2*0.5664 |
| 0011 | (π/2, 0.5654) | 0 | 1*0.5664 |
| 0010 | (3π/4, 0.5664) | −\sqrt{2}/2*0.5664 | \sqrt{2}/2*0.5664 |
| 0110 | (π, 0.5664) | −1*0.5664 | 0 |
| 0111 | (−3π/4, 0.5664) | −\sqrt{2}/2*0.5664 | −\sqrt{2}/2*0.5664 |
| 0101 | (−π/2, 0.5664) | 0 | −1*0.5664 |
| 0100 | (−π/4, 0.5664) | \sqrt{2}/2*0.5664 | −\sqrt{2}/2*0.5664 |

In the instance where the configuration of FIG. 4c is used to transmit an aggregate of 100 Gbps presented at the input interface 2015, the modulator comprises a nest of two duel drive Mach-Zehnder modulators 2061, whose outputs are optically combined according to prior art. While the phasor diagram associated with this example is different in detail from that associated with the examples of FIGS. 4a and 4b and illustrated in FIG. 5, the net effect is that the combined data stream is transmitted at the same significantly lower symbol rate than would otherwise be if a similar transmission were to be attempted according to prior art.

In these illustrative examples the large serial data stream of 100 Gbps is transported over two DWDM channels each transmitting half of the input serial data stream at 12.5 Gigs symbols per second. This rate is only marginally higher than the optimum channel capacity of 10 Gbps.

From these examples it can be seen that the present invention provides two approaches in which its method and apparatus can transmit and receive increasingly larger serial data streams with conformance to the signal interface constraints of a pre-installed transmission system thus minimising bit error rate for both the large serial data streams and the pre-installed streams. The first approach is to increase the parameter N used in the scaling of the encoder, the modulation pulse former and the modulator sections of the apparatus. The extent to which N can be increased is limited by the prevailing speeds of electronic and optical technologies. However for a given achievable N value, the number of K symbol groups may be increased thereby achieving a corresponding increase in the size of the serial data stream that can be transmitted according to the present invention.

An Exemplary Receiver

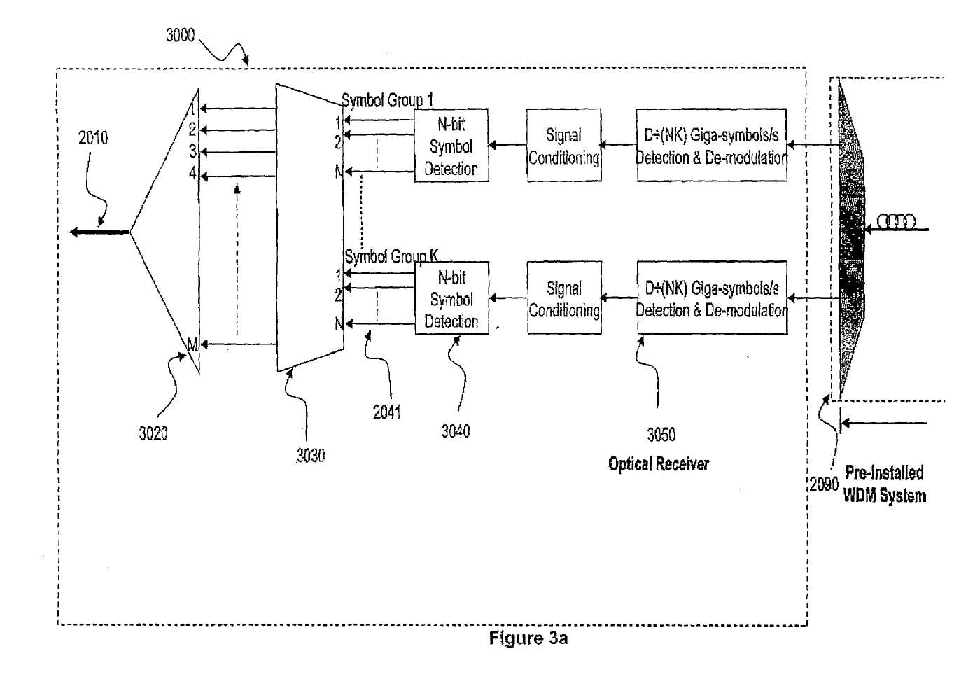

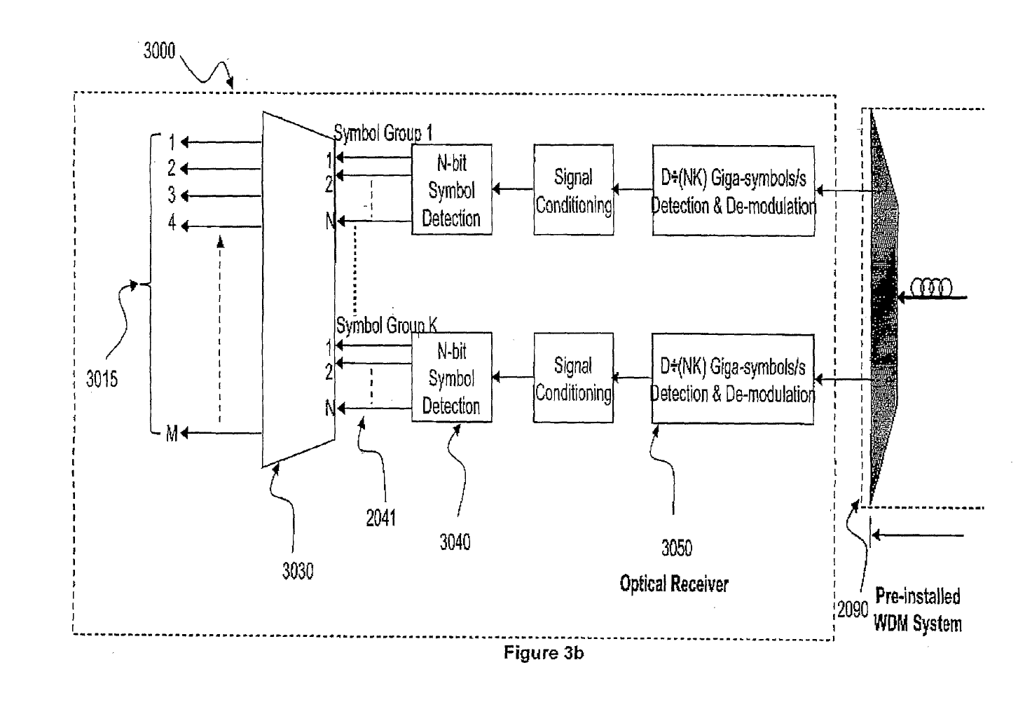

FIG. 3a is a block diagram depicting the functions of a receiver 3000 as an exemplary embodiment of the present invention. The receiver 3000 according to the present invention consists of an optical receiver 2050 associated with each of the K channels received from the transmission system 2090. The optical receiver regenerates the symbols originally transmitted. The symbol signal stream is processed by the signal conditioner 3040 to minimize the impact of noise and fibre non linearity during transmission. The resulting K symbol groups 2041 drive the N-bit decoder 3030, which in turn decodes the symbols into the original data streams organized into M streams. The M streams are then processed through the de-framer section of the de-framer and serializer 3020 which in preference performs multi-lane de-skew functions where required, correcting bit errors, adding performance monitoring function and/or in-band management functions and through the serializer section of the de-framer and serializer 3020 to restore the original large serial data stream 2010.

The optical receiver 3050 may preferably be constructed using the well understood principles of optical coherent detection accompanied by N-bit symbol detection 3040, N-bit decoding and partial de-serialization 3030, all these being new functions according to the present invention.

Although the invention has been herein shown and described in what is conceived to be the most practical and preferred embodiment, it is recognized that departures can be made within the scope of the invention, which is not to be limited to the details described herein but it is to be accorded the full scope of the appended claims so as to embrace any and all equivalent devices and apparatus.

What is claimed is:

1. A method to transmit and receive significantly larger serial data stream to achieve conformance to signal interface constraints of a pre-installed transmission system thus minimising bit error rate for both large serial data streams and pre-installed streams comprising:
de-serialising an initial incoming signal at a first data rate D into M data streams, wherein M>2, each M data stream having a data rate of D/M Gbps, framing and error coding the M data streams in accordance with established standards, within processing capabilities of prior art;
partially serialising and encoding M data streams into K symbol groups where K is an integer greater than or equal to 1, each K symbol group characterized by N concurrent data bits of the N data streams, wherein each of said N data streams has a data rate of D/(N·K);
processing each of the K symbol groups to provide K modulated output signals;
transmitting the K modulated output signals via K channels of an existing wavelength division multiplexing system.

2. The method of claim 1, wherein the processing of each of the K symbol groups includes the steps of:
modulation pulse forming, N bits at a time;
optical modulation, N bits per symbol; and
signal conditioning.

3. The method of claim 2, wherein the processing includes utilizing an N-bit encoder.

4. The method of claim 3, further comprising generating N-bit symbols in groups K using said N-bit encoder, to correspond with constraints of the pre-installed transmission system.

5. The method of claim 4, wherein said generating said N-bit symbols comprises generating symbols having >=3 bits per symbol.

6. The method of claim 5, further comprising conditioning a signal such that a wavelength transmitted in relation to each K-symbol group has a negative initial residual chromatic dispersion and a residual chromatic dispersion is appropriately trimmed at a receiver of the pre-installed transmission system.

7. The method of claim 6, further comprising utilizing an optical receiver as the receiver is.

8. The method of claim 7, further comprising utilizing an optical receiver that has N-bit detection, N-bit decoding and partial de-serialisation.
